(19) United States
(12) Patent Application Publication
(10) Pub. No.: US 2026/0331760 A1
(43) Pub. Date: Oct. 22, 2026

(54) RADOME, ANTENNA, AND COMMUNICATION DEVICE

(71) Applicant: HUAWEI TECHNOLOGIES CO., LTD., Shenzhen (CN)

(72) Inventors: Liangyuan Li, Dongguan (CN); Chi Zhan, Shenzhen (CN); Ning Yi, Dongguan (CN); Meng Xiao, Dongguan (CN)

(73) Assignee: HUAWEI TECHNOLOGIES CO., LTD., Shenzhen (CN)

(21) Appl. No.: 19/701,645

(22) Filed: Jun. 8, 2026

Related U.S. Application Data
(63) Continuation of application No. PCT/CN2024/135255, filed on Nov. 28, 2024.

(30) Foreign Application Priority Data
Dec. 7, 2023 (CN) 202323364505.X

(51) Int. Cl. H01Q 1/42; H01Q 1/24

(52) U.S. Cl. CPC H01Q 1/422; H01Q 1/246

(57) ABSTRACT

This application provides a radome, an antenna, and a communication device. The radome includes a top cover and a side frame. The top cover is connected to the side frame to form an accommodation cavity for accommodating a radiating element. An end face of the top cover is embedded into the side frame. In this way, a connection strength between the top cover and the side frame can be increased, to prevent the top cover and the side frame from being separated from each other, thereby improving reliability of the radome.

### CROSS-REFERENCE TO RELATED APPLICATIONS

This application is a continuation of International Application No. PCT/CN2024/135255, filed on Nov. 28, 2024, which claims priority to Chinese Patent Application No. 202323364505.X, filed on Dec. 7, 2023. The disclosures of the aforementioned applications are hereby incorporated by reference in their entireties.

### TECHNICAL FIELD

This application relates to the field of communication technologies, and in particular, to a radome, an antenna, and a communication device.

### BACKGROUND

As a protective housing of an antenna, a radome ensures normal operation of an internal component of the antenna. In addition, the radome has good electromagnetic wave penetration characteristics in electrical performance, and can withstand impact of an external harsh environment in mechanical performance, so that the antenna can be protected from the impact of the external environment. Because the radome is exposed in an outdoor environment for a long time, if the radome has poor reliability, when the radome is damaged, for example, cracked, the internal component is exposed to the external environment, and consequently the component is affected by the external environment and cannot work normally. Therefore, how to improve reliability of the radome becomes an urgent problem to be resolved in this field.

### SUMMARY

This application provides a radome, an antenna, and a communication device, to improve reliability of the radome.

According to a first aspect, an embodiment of this application provides a radome, where the radome may include a top cover and a side frame, the top cover is connected to the side frame to form an accommodation cavity for accommodating a radiating element, and an end face of the top cover is embedded into the side frame. In this way, a connection strength between the top cover and the side frame can be increased, to prevent the top cover and the side frame from being separated from each other, thereby improving reliability of the radome.

When the end face of the top cover is embedded into the side frame, the end face may be embedded into the side frame in a direction perpendicular to a thickness of the top cover, and the end face of the top cover is welded or glued to the side frame. In this way, a connection strength between connection interfaces can be increased, and reliability of the radome can be further improved.

Optionally, a through hole may be disposed in the top cover embedded into the side frame, the through hole penetrates the top cover in a thickness direction of the top cover, the side frame has an extension part, and the extension part is inserted into the through hole. In this way, a connection strength between the top cover and the side frame can be further increased, and reliability of the radome can be further improved. In addition, the radome may further pass a hoisting collision test and an impact resistance test. The side frame may include a body and the extension part, and a manufacturing material of the extension part may be the same as that of the body. In this case, the extension part and the body may be an integrally formed structure. In this way, a connection strength between the extension part and the body may be increased, thereby improving reliability of the radome. Alternatively, a manufacturing material of the extension part may be different from that of the body. In this case, the extension part and the body may be two independent structures connected together.

Optionally, a first connecting part is disposed at one end that is of the top cover and that is connected to the side frame, a second connecting part is disposed at one end that is of the side frame and that is connected to the top cover, and the first connecting part is matingly connected to the second connecting part. In this way, the first connecting part is matingly connected to the second connecting part, so that a joint area of the top cover and the side frame can be increased, thereby further increasing a connection strength between the top cover and the side frame, and further improving reliability of the radome.

The first connecting part and the second connecting part may be any structure that can implement adaptive connection and that is well known by a person skilled in the art. For example, but not limited thereto, the first connecting part is a notch or a groove, and the second connecting part is a protrusion; or the first connecting part is a protrusion, and the second connecting part is a notch or a groove. This is not limited herein. In this way, the protrusion may be inserted into the notch or the groove, thereby increasing a joint area of the top cover and the side frame, and increasing a connection strength between the top cover and the side frame.

Optionally, a manufacturing material of the top cover includes a continuous fiber-reinforced thermoplastic resin. The continuous fiber-reinforced thermoplastic resin may include but is not limited to at least one of a fiber woven prepreg and a UD laminated composite material. The fiber woven prepreg is a prepreg formed by impregnating a fabric woven from fibers in a thermoplastic resin. A UD continuous fiber prepreg is a UD continuous fiber prepreg formed by arranging continuous fibers in a unidirectional direction, impregnating the continuous fibers in a thermoplastic resin to form a single-layer prepreg, and then laminating at least two layers of the single-layer prepreg in different directions. In this way, fibers in the top cover are continuous fibers, which are long, and weaving can be performed by using such fibers. Therefore, these continuous fibers can absorb higher impact energy, and the top cover has higher impact resistance performance and a better stress dispersion capability. A continuous fiber-reinforced resin may also be referred to as a high-strength light material. Compared with a top cover made of a single homogeneous material, the top cover made of the continuous fiber-reinforced resin can effectively reduce the thickness of the top cover, thereby reducing a weight of the top cover. For example, the weight of the top cover can be significantly reduced by 35% to 45%.

A manufacturing material of the side frame includes a thermoplastic resin or a short fiber-reinforced thermoplastic resin. In this way, when the manufacturing material of the side frame includes the short fiber-reinforced thermoplastic resin, fibers in the side frame are short fibers, which are short. The short fiber can be used to improve impact resistance performance of the side frame and reduce a weight. In addition, the manufacturing material of the side frame is a resin material, which facilitates molding and facilitates production of a required shape. In addition, when the side frame is manufactured by using the thermoplastic resin, a material having a desired impact resistance performance may be selected. The selection may be performed based on a requirement on impact resistance performance of the side frame, so that impact resistance performance can be improved to some extent, and a requirement for protecting an internal component of the radome is met.

According to a second aspect, an embodiment of this application provides a radome, where the radome may include a top cover and a side frame, the top cover is connected to the side frame to form an accommodation cavity for accommodating a radiating element, one end that is of the side frame and that faces the top cover has a step, the top cover is lapped onto the step, and the top cover is welded to the side frame. In this way, assembly difficulty of the side frame and the top cover can be simplified, and manufacturing difficulty of the radome can be reduced. In addition, effective combination of the top cover and the side frame can be implemented through welding, thereby improving reliability of the radome.

Optionally, the step is disposed on a surface of one side that is of the side frame and that is away from the accommodation cavity, or the step is disposed on a surface of one side that is of the side frame and that faces the accommodation cavity. A position of the step may be set based on an actual requirement, provided that the top cover can be lapped onto the side frame.

When the step is disposed on the surface of the side that is of the side frame and that is away from the accommodation cavity, the surface of the side that is of the side frame and that is away from the accommodation cavity in a first direction is flush with a surface of one side that is of the top cover and that is away from the accommodation cavity in the first direction, and the first direction is a direction perpendicular to the surface of the top cover. In this way, there is no breakage in appearance and the appearance is more beautiful. If the surface of the side that is of the top cover and that is away from the accommodation cavity in the first direction is referred to as an outer surface of the top cover, and the surface of the side that is of the top cover and that faces the accommodation cavity in the first direction is referred to as an inner surface of the top cover, in a scenario in which the radome is affected by external impact, the side frame may provide a support function for the top cover from the inner surface, to prevent the top cover and the side frame from being separated from each other, thereby improving reliability of the radome.

When the step is disposed on the surface of the side that is of the side frame and that faces the accommodation cavity, the inner surface of the side that is of the top cover and that faces the accommodation cavity in the first direction is flush with the surface of the side that is of the side frame and that faces the accommodation cavity in the first direction. In this way, the side frame can provide support for the top cover from the outer surface, to prevent the top cover and the side frame from being separated from each other when a component in the accommodation cavity is ejected outward, thereby improving reliability of the radome.

It should be understood that a first connecting part and a second connecting part may also be disposed in such radome, a manufacturing material of the top cover includes a continuous fiber-reinforced thermoplastic resin, and a manufacturing material of the side frame includes a thermoplastic resin or a short fiber-reinforced thermoplastic resin. A manner of disposing the first connecting part and the second connecting part is basically the same as the manner of disposing the first connecting part and the second connecting part in the first aspect, and disposing of the manufacturing material of the top cover and the manufacturing material of the side frame is basically the same as the disposing of the manufacturing material of the top cover and the manufacturing material of the side frame in the first aspect. For details, refer to related descriptions in the first aspect. Details are not described again.

According to a third aspect, an embodiment of this application further provides a radome, where the radome may include a top cover and a side frame, the top cover is connected to the side frame to form an accommodation cavity for accommodating a radiating element, a manufacturing material of the top cover may include at least one of a first resin, a continuous fiber-reinforced resin, a fiber mat prepreg, and a skin material, namely, a sandwich structure composite material including continuous fibers, and a manufacturing material of the side frame may include a second resin or a short fiber-reinforced resin, where the first resin is different from the second resin, so that different materials may be used to manufacture the top cover and the side frame. In this way, different materials may be selected based on actual requirements to control performance of the top cover and performance of the side frame. For example, when the top cover requires high impact resistance performance, but the side frame does not require such high impact resistance performance, a material with high impact resistance performance may be used to manufacture the top cover, and a common material may be used to manufacture the side frame. In this way, a performance requirement of each structure can be met, and manufacturing costs of the radome can be reduced. It should be understood that both the first resin and the second resin are resins to which no enhancer is added, or the first resin and the second resin may be understood as pure resins.

When the manufacturing material of the top cover includes at least one of the continuous fiber-reinforced resin, the fiber mat prepreg, and the skin material, namely, the sandwich structure composite material including continuous fibers, fibers in the top cover are continuous fibers, which are long, and weaving can be performed by using such fibers. Therefore, these continuous fibers can absorb higher impact energy, and the top cover has higher impact resistance performance and a better stress dispersion capability. A continuous fiber-reinforced resin may also be referred to as a high-strength light material. Compared with a top cover made of a single homogeneous material, the top cover made of the continuous fiber-reinforced resin can effectively reduce the thickness of the top cover, thereby reducing a weight of the top cover. For example, the weight of the top cover can be significantly reduced by 35% to 45%.

The continuous fiber-reinforced resin may include but is not limited to at least one of a fiber woven prepreg and a UD laminated composite material. The fiber woven prepreg is a prepreg formed by impregnating a fabric woven from fibers in a thermoplastic resin. A UD continuous fiber prepreg is a UD continuous fiber prepreg formed by arranging continuous fibers in a unidirectional direction, impregnating the continuous fibers in a thermoplastic resin to form a single-layer prepreg, and then laminating at least two layers of the single-layer prepreg in different directions.

The fiber mat prepreg is a prepreg formed by irregularly arranging fibers and impregnating the fibers in the thermoplastic resin.

The sandwich structure composite material includes an upper skin, a lower skin, and a sandwich disposed between the upper skin and the lower skin. Manufacturing materials of the upper skin and the lower skin may both include: a fiber woven prepreg, a UD continuous fiber prepreg, a fiber mat prepreg, or a long-cut fiber-reinforced resin, so that the manufacturing materials of the upper skin and the lower skin both include continuous fibers. Definitely, the manufacturing materials of the upper skin and the lower skin may further include a short-cut fiber-reinforced resin and the like. This may increase impact resistance performance of the top cover to some extent. Due to a special structure of the sandwich structure composite material, a density of the material is low, so that a density of the top cover can be reduced, thereby reducing a weight of the radome and implementing a lightweight design.

The top cover may be set as a flat plate structure. When the continuous fiber-reinforced resin is used for manufacturing, the top cover may be set to be thin. Manufacturing costs of the top cover can be reduced, for example, the manufacturing costs can be reduced by 40%, and the radome may be formed after the top cover is connected to the side frame without additional thermal forming, thereby reducing manufacturing difficulty of the radome and simplifying a manufacturing process. A shape of the top cover may be any shape set based on an actual requirement, for example, but is not limited to a circle, an ellipse, a triangle, a quadrilateral, or another shape. This is not limited herein.

The first resin may be a thermoplastic resin or a thermosetting resin having high impact resistance performance, for example, but is not limited to: including PC (polycarbonate) and PU (polyurethane), and an impact resistance strength of the first resin may be greater than or equal to 10 KJ/m², to meet a performance requirement of the top cover when the top cover is used outdoors.

When the manufacturing material of the side frame includes the short fiber-reinforced resin, fibers in the side frame are short fibers, which are short. The short fiber can be used to improve impact resistance performance of the side frame and reduce a weight. In addition, the manufacturing material of the side frame is a resin material, which facilitates molding and facilitates production of a required shape.

When the short fiber-reinforced resin is used for manufacturing, a length of the short fiber may be not greater than 25 mm, for example, but not limited to: the short fiber may be a short-cut glass fiber, and a length of the short-cut glass fiber may be 0.7 mm to 1 mm; or the short fiber may be a long-cut glass fiber, and a length of the long-cut glass fiber may be 6 mm to 25 mm. A material of the short fiber may be, but is not limited to, one or a combination of the following: a glass fiber, a quartz fiber, and a mineral fiber. Using such fiber may enhance impact resistance performance of the resin, thereby improving impact resistance performance of the side frame. In addition, when the side frame is manufactured by using the resin, a material having a desired impact resistance performance may be selected. The selection may be performed based on a requirement on impact resistance performance of the side frame, so that impact resistance performance can be improved to some extent, and a requirement for protecting an internal component of the radome is met.

An impact resistance strength of the second resin may be less than that of the first resin, and the second resin may be a thermoplastic resin or a thermosetting resin, for example, but is not limited to: including an ABS (acrylonitrile-butadiene-styrene copolymer), a PC-ABS alloy, a nylon, a polyester, a polysulfone, a polyimide, a polyether, and the like. There is no high requirement on the impact resistance strength of the second resin, provided that the requirement is met. This is not limited herein.

Based on this, the top cover and the side frame are made of different materials, and the top cover is made of a high-strength light material, so that a lightweight design of the radome can be implemented, thereby reducing an overall weight of the radome by 55%. In addition, the radome has high impact resistance performance, and passes a hoisting collision test and an impact resistance test, thereby improving reliability of the radome.

It should be understood that a structure of the radome in the third aspect may be the same as the structure of the radome described in the first aspect or the structure of the radome described in the second aspect. For details, refer to the related descriptions in the first aspect or the second aspect. Details are not described again.

According to a fourth aspect, an embodiment of this application further provides a radome manufacturing method. The manufacturing method is used to manufacture the radome described in any one of the first aspect and embodiments of the first aspect, or any one of the second aspect and embodiments of the second aspect, or any one of the third aspect and embodiments of the third aspect. The manufacturing method may include: laying a manufacturing material of a top cover on a front mold, positioning the manufacturing material in a mold through vacuum adsorption; closing the mold; and injecting a melt resin into a mold cavity to form a side frame. In this way, connection between the top cover and the side frame may be implemented in the mold, and the manufacturing material of the top cover and a manufacturing material of the side frame may be welded to each other in the mold, thereby increasing a connection strength between connection interfaces and improving reliability of the manufactured radome.

Optionally, when a through hole is disposed in the top cover, before the mold is closed, the method may further include: manufacturing the through hole at an end of the laid manufacturing material. Then, when the melt resin is injected into the mold cavity, the melt resin also enters the through hole to form an extension part, so that the extension part is formed while a body of the side frame is formed, thereby improving a strength of combination between the top cover and the side frame, and further improving reliability of the manufactured radome.

Optionally, when a first connecting part is disposed in the top cover, and a second connecting part is disposed in the side frame, before the mold is closed, the method may further include: manufacturing the first connecting part at the end of the laid manufacturing material, and then injecting the melt resin into the mold cavity to form the side frame, where the formed side frame has the second connecting part. In this way, a strength of combination between the top cover and the side frame can be improved, thereby further improving reliability of the manufactured radome.

It should be understood that, because a problem-resolving principle of the radome manufactured by using the manufacturing method is similar to the problem-resolving principle of the radome described in any one of the foregoing aspects, for implementation and technical effects of the manufacturing method, refer to the implementation and the technical effects of the radome described in any one of the foregoing aspects. No repeated description is provided.

According to a fifth aspect, an embodiment of this application further provides an antenna, where the antenna may include a radiating element, and the radome described in any one of the first aspect and embodiments of the first aspect, or the radome described in any one of the second aspect and embodiments of the second aspect, or the radome described in any one of the third aspect and embodiments of the third aspect, and the radome may cover the radiating element. In this way, the radome can protect the radiating element, prevent the radiating element from being affected by an external environment, and have good electromagnetic wave penetration characteristics in electrical performance, so that the antenna has good stability and reliability while that the antenna can work normally is ensured.

It should be understood that, because a problem-resolving principle of the antenna is similar to the problem-resolving principle of the radome, for implementation and technical effects of the antenna, refer to the implementation and the technical effects of the radome. No repeated description is provided.

According to a sixth aspect, an embodiment of this application further provides a communication device. The communication device may include the antenna described in any one of the fifth aspect and embodiments of the fifth aspect. Certainly, in addition to the antenna, the communication device may further include another device or apparatus, for example, a terminal. This may be designed based on an actual requirement, and is not limited herein. The antenna is used, so that signal receiving and sending with the terminal can be implemented, and communication with the terminal can be implemented. On the basis that the antenna has good stability and reliability, the communication device can also have good stability and reliability.

It should be understood that, because a problem-resolving principle of the communication device is similar to the problem-resolving principle of the antenna, for implementation and technical effects of the communication device, refer to the implementation and the technical effects of the antenna. No repeated description is provided.

### BRIEF DESCRIPTION OF DRAWINGS

FIG. 1 is a diagram of a structure of a communication device according to an embodiment of this application;

FIG. 2 is a diagram of a structure of an antenna according to an embodiment of this application;

FIG. 3 is a three-dimensional diagram of a part of a radome according to an embodiment of this application;

FIG. 4A and FIG. 4B are a diagram of a cross section shown in FIG. 3; and

FIG. 5A and FIG. 5B are another diagram of a cross section shown in FIG. 3.

### DESCRIPTION OF EMBODIMENTS

To make the objectives, technical solutions, and advantages of this application clearer, the following further describes this application in detail with reference to the accompanying drawings.

It should be noted that same reference numerals in the accompanying drawings of this application indicate same or similar structures. Therefore, repeated descriptions thereof are omitted. Expressions of locations and directions in this application are described by using the accompanying drawings as an example. However, changes may also be made as required, and all the changes fall within the protection scope of this application. The accompanying drawings in this application are merely used to illustrate relative position relationships and do not represent an actual scale.

To facilitate understanding of the technical solutions provided in embodiments of this application, the following first describes application scenarios of the technical solutions.

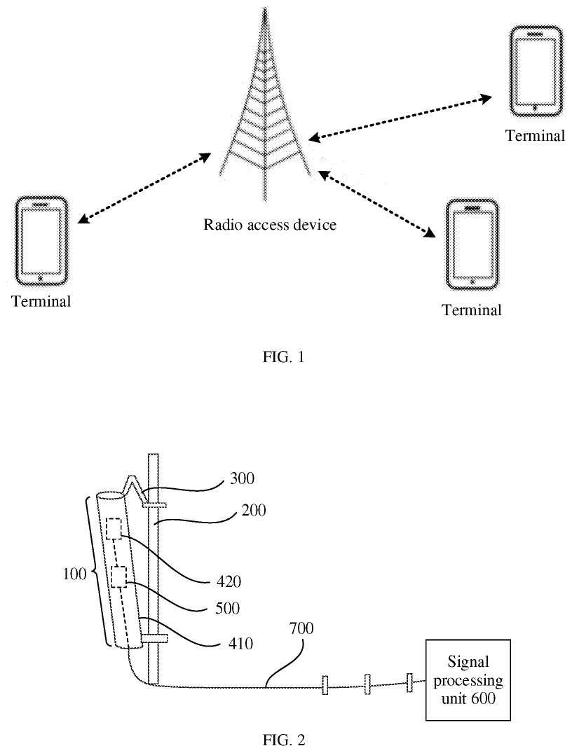

The technical solutions provided in embodiments of this application may be applied to other fields that require an antenna, such as the communication field, the radar field, or the meteorological field. FIG. 1 is an example of a diagram of an architecture of a communication device to which an embodiment of this application is applicable. As shown in FIG. 1, the communication device may include a radio access device and a terminal. The radio access device includes but is not limited to the base station shown in FIG. 1. Wireless communication may be implemented between a wireless access device and the terminal. The wireless access device may be located in a base station subsystem (BSS), a universal terrestrial radio access network (UTRAN), or an evolved universal terrestrial radio access network (E-UTRAN), and is configured to perform cell coverage of a radio signal, to implement connection between a terminal device and a radio frequency end of a wireless network. The base station may be a base station (BTS) in a global system for mobile communications (GSM) device or a code division multiple access (CDMA) system, or may be a base station (NodeB, NB) in a wideband code division multiple access (WCDMA) system, or may be an evolved NodeB (eNB or eNodeB) in an LTE system, or may be a radio controller in a cloud radio access network (CRAN) scenario, or the base station may be a relay station, an access point, a vehicle-mounted device, a wearable device, or a base station in a 5G network, or a base station in a future evolved PLMN network, for example, a new radio base station. This is not limited in embodiments of this application.

FIG. 2 is an example of a diagram of a structure of an antenna feeding system of a base station according to an embodiment shown in FIG. 1. The antenna feeding system of the base station may generally include structures such as an antenna 100, a pole 200, and an antenna adjustment support 300. The antenna 100 of the base station includes a radome 410 and a radiating element 420. The radome 410 covers the radiating element 420. The radome 410 has good electromagnetic wave penetration characteristics in electrical performance, and can withstand impact of an external harsh environment in mechanical performance, so that an antenna system can be protected from the impact of the external environment. The radome 410 may be mounted on the pole 200 or a tower via the antenna adjustment support 300, to facilitate signal receiving or transmitting of the antenna 100.

In addition, the base station may further include a radio frequency processing unit 500 and a signal processing unit 600. For example, the radio frequency processing unit 500 may be configured to: perform frequency selection, amplification, and down-conversion processing on a signal received by the radiating element 420, convert the signal into an intermediate frequency signal or a baseband signal, and send the intermediate frequency signal or the baseband signal to the signal processing unit 600. Alternatively, the radio frequency processing unit 500 is configured to: perform up-conversion and amplification processing on an intermediate frequency signal of the signal processing unit 600, convert the signal into an electromagnetic wave via the radiating element 420, and send the electromagnetic wave. The signal processing unit 600 may be connected to the radiating element 420 via the radio frequency processing unit 500, and is configured to process an intermediate frequency signal or a baseband signal sent by the radio frequency processing unit 500. As shown in FIG. 2, the radio frequency processing unit 500 may be integrated with the radiating element 420, and the signal processing unit 600 is located at a remote end of the antenna 100. The radio frequency processing unit 500 and the signal processing unit 600 may be connected via a cable 700.

Because the radome is exposed in an outdoor environment for a long time, if the radome has poor reliability, when the radome is damaged, for example, cracked, the internal component is

AT exposed to the external environment, and consequently the component is affected by the external environment and cannot work normally. Based on this, an embodiment of this application provides a radome, to improve reliability of the radome, thereby protecting an internal component of the radome.

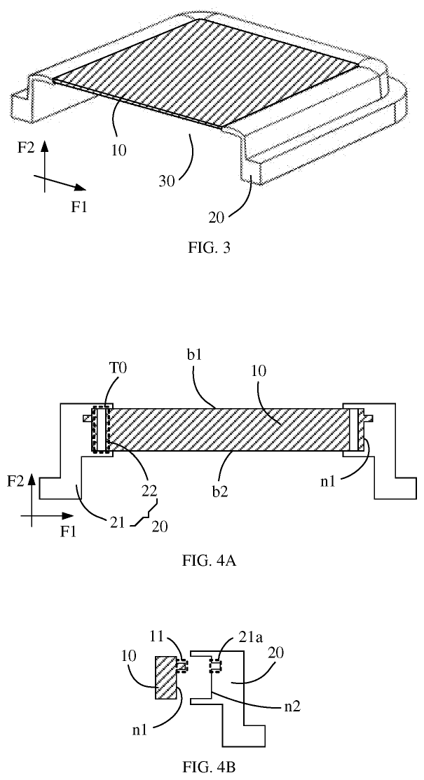

FIG. 3 and FIG. 4A and FIG. 4B are examples of diagrams of structures of an embodiment of a radome according to this application. Refer to FIG. 3 and FIG. 4A and FIG. 4B. The radome may include a top cover 10 and a side frame 20. The top cover 10 is connected to the side frame 20 to form an accommodation cavity 30 for accommodating a radiating element, and an end face n1 of the top cover 10 is embedded into the side frame 20. Optionally, a thickness direction of the side frame 20 is an F2 direction, a direction perpendicular to the thickness direction of the side frame 20 is an F1 direction, and the end face n1 of the top cover 10 is embedded into the side frame 20 in the F1 direction. In addition, the side frame 20 covers a part of an inner surface b2 of the top cover 10, and covers a part of an outer surface b1 of the top cover 10, so that both the inner surface b2 and the outer surface b1 of the top cover 10 are combined and connected to the side frame 20. In this way, a connection strength between the top cover 10 and the side frame 20 can be increased, and the top cover 10 and the side frame 20 can be prevented from being separated from each other in a scenario in which the radome is subjected to external impact, and further the top cover 10 and the side frame 20 may be prevented from being separated from each other when a component in the accommodation cavity is ejected outward, thereby effectively improving reliability of the radome.

A length of the top cover 10 embedded into the side frame 20 in the F1 direction may be designed based on an actual requirement. For example, when a high connection strength is required, the length of the top cover 10 embedded into the side frame 20 in the F1 direction may be set to a larger value. When a large volume of the accommodation cavity is required and a high connection strength is not required, the length of the top cover 10 embedded into the side frame 20 in the F1 direction may be set to a smaller value. A value is not limited herein.

In addition, that the top cover 10 is connected to the side frame 20 may be set as: the end face n1 of the top cover 10 is welded or glued to the side frame 20. In this way, a connection strength between connection interfaces can be increased, and reliability of the radome can be further improved. It should be understood that the welding may be understood as welding formed during welding/splicing or welding formed during injection molding.

As shown in FIG. 4A, a through hole TO may be disposed in the top cover 10 embedded into the side frame 20, the through hole TO penetrates the top cover 10 in the F2 direction, the side frame 20 has an extension part 22, and the extension part 22 is inserted into the through hole TO. In this way, a connection strength between the top cover 10 and the side frame 20 can be further increased, and reliability of the radome can be further improved. In addition, the radome may further pass a hoisting collision test and an impact resistance test. The side frame 20 may include a body 21 and the extension part 22, and a manufacturing material of the extension part 22 may be the same as that of the body 21. In this case, the extension part 22 and the body 21 may be an integrally formed structure. In this way, a connection strength between the extension part 22 and the body 21 may be increased, thereby improving reliability of the radome. Alternatively, a manufacturing material of the extension part 22 may be different from that of the body 21. In this case, the extension part 22 and the body 21 may be two independent structures connected together.

As shown in FIG. 4B, FIG. 4B is a partial enlarged diagram of a joint between the top cover 10 and the side frame 20 in FIG. 4A. In addition, for ease of viewing structures, the top cover 10 and the side frame 20 are separated from each other, but in an actual situation, the two are connected. To improve the connection strength between the top cover 10 and the side frame 20, it may be further set as: a first connecting part 11 is disposed at one end n1 that is of the top cover 10 and that is connected to the side frame 20, a second connecting part 21a is disposed at one end n2 that is of the side frame 20 and that is connected to the top cover 10, and the first connecting part 11 is matingly connected to the second connecting part 21a. In this way, the first connecting part 11 is matingly connected to the second connecting part 21a, so that a joint area of the top cover 10 and the side frame 20 can be increased, thereby further increasing a connection strength between the top cover 10 and the side frame 20, and further improving reliability of the radome.

The first connecting part 11 and the second connecting part 21a may be any mating structures that are well known by a person skilled in the art. For example, but not limited thereto, the first connecting part 11 is a notch or a groove, and the second connecting part 21a is a protrusion, which is not shown in the figure; or the first connecting part 11 is a protrusion, and the second connecting part 21a is a notch or a groove, as shown in FIG. 4B. This is not limited herein. In this way, the protrusion may be inserted into the notch or the groove, thereby increasing a joint area of the top cover 10 and the side frame 20, and increasing a connection strength between the top cover 10 and the side frame 20.

It should be understood that, in the radome, the top cover 10 may be considered as a radiation surface of the radome, and may implement transmission of a radio frequency signal. The side frame 20 may be considered as a waterproof structure, and may implement a waterproof function, to prevent external water vapor from entering the radome and causing adverse impact on the component in the accommodation cavity 30. A shape of the side frame 20 may be determined based on a design requirement of the radome, for example, but is not limited to: a shape of a cross section of the side frame 20 may be a shape of a vertical side with upper and lower corners (as shown in FIG. 3), a shape of a vertical side without a corner (not shown in the figure), or another special shape. This is not limited herein. The top cover 10 may be disposed as a flat plate structure, or certainly may be disposed as another structure. This is not limited herein.

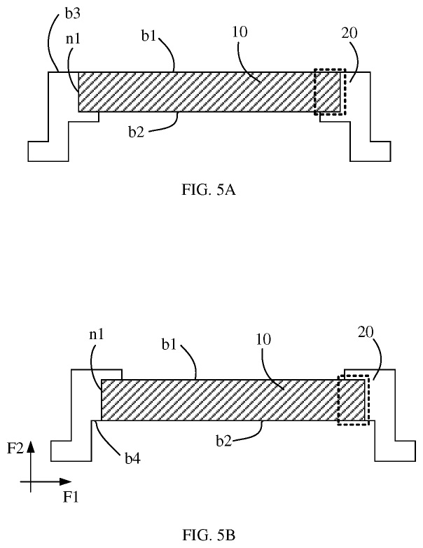

FIG. 5A and FIG. 5B are an example of a diagram of a structure of an embodiment of a radome according to this application. Refer to FIG. 5A and FIG. 5B. A structure of the radome in this embodiment is basically similar to the structure of the radome shown in FIG. 3 and FIG. 4A and FIG. 4B in the foregoing embodiments. A difference lies in that the side frame 20 is lapped onto the top cover 10. Optionally, one end that is of the side frame 20 and that faces the top cover 10 has a step (as shown in a dashed line box), the top cover 10 is lapped onto the step, and the top cover 10 is welded to the side frame 20. In this way, assembly difficulty of the side frame 20 and the top cover 10 can be simplified, and manufacturing difficulty of the radome can be reduced. In addition, effective combination of the top cover 10 and the side frame 20 can be implemented through welding, thereby improving reliability of the radome.

A step setting manner may include any one of the following manners.

First manner: as shown in FIG. 5A, the step is disposed on a surface of one side that is of the side frame 20 and that is away from the accommodation cavity. In this case, the side frame 20 covers a part of the inner surface b2 of the top cover 10 in the F2 direction, and the outer surface b1 of the top cover 10 in the F2 direction is flush with the surface b3 of the side that is of the side frame 20 and that is away from the accommodation cavity in the F2 direction. In this way, there is no breakage in appearance and the appearance is more beautiful. In a scenario in which the radome is affected by external impact, the side frame 20 may provide a support function for the top cover 10 from the inner surface b2, to prevent the top cover 10 and the side frame 20 from being separated from each other, thereby improving reliability of the radome.

Second manner: as shown in FIG. 5B, the step is disposed on a surface of one side that is of the side frame 20 and that faces the accommodation cavity. In this case, the side frame 20 covers a part of the outer surface b1 of the top cover 10 in the direction F2. The inner surface b2 of the top cover 10 in the direction F2 is flush with the surface b4 of the side that is of the side frame 20 and that faces the accommodation cavity in the direction F2. In this way, the side frame 20 can provide support for the top cover 10 from the outer surface b1, to prevent the top cover 10 and the side frame 20 from being separated from each other when a component in the accommodation cavity is ejected outward, thereby improving reliability of the radome. Certainly, the inner surface b2 of the top cover 10 in the F2 direction may not be flush with the surface b4 of the side that is of the side frame 20 and that faces the accommodation cavity in the F2 direction. This may be determined based on an actual situation, and is not limited herein.

It should be understood that, for similarities between the structure of the radome in this embodiment and the structure of the radome shown in FIG. 3 and FIG. 4A and FIG. 4B in the foregoing embodiments, refer to the related descriptions in the foregoing embodiments. Repeated parts are not described again.

For example, in another embodiment of a radome of this application, the radome may include a top cover and a side frame. The top cover is connected to the side frame to form an accommodation cavity for accommodating a radiating element, a manufacturing material of the top cover may include at least one of a first resin, a continuous fiber-reinforced resin, a fiber mat prepreg, and a skin material, namely, a sandwich structure composite material including continuous fibers, and a manufacturing material of the side frame may include a second resin or a short fiber-reinforced resin, where the first resin is different from the second resin, so that different materials may be used to manufacture the top cover and the side frame. In this way, different materials may be selected based on actual requirements to control performance of the top cover and performance of the side frame. For example, when the top cover requires high impact resistance performance, but the side frame does not require such high impact resistance performance, a material with high impact resistance performance may be used to manufacture the top cover, and a common material may be used to manufacture the side frame. In this way, a performance requirement of each structure can be met, and manufacturing costs of the radome can be reduced. It should be understood that both the first resin and the second resin are resins to which no enhancer is added, or the first resin and the second resin may be understood as pure resins.

When the manufacturing material of the top cover includes at least one of the continuous fiber-reinforced resin, the fiber mat prepreg, and the skin material, namely, the sandwich structure composite material including continuous fibers, fibers in the top cover are continuous fibers, which are long, and weaving can be performed by using such fibers. Therefore, these continuous fibers can absorb higher impact energy, and the top cover has higher impact resistance performance and a better stress dispersion capability. A continuous fiber-reinforced resin may also be referred to as a high-strength light material. Compared with a top cover made of a single homogeneous material, the top cover made of the continuous fiber-reinforced resin can effectively reduce the thickness of the top cover, thereby reducing a weight of the top cover. For example, the weight of the top cover can be significantly reduced by 35% to 45%.

The continuous fiber-reinforced resin may include but is not limited to at least one of a fiber woven prepreg and a UD laminated composite material. The fiber woven prepreg is a prepreg formed by impregnating a fabric woven from fibers in a thermoplastic resin. A UD continuous fiber prepreg is a UD continuous fiber prepreg formed by arranging continuous fibers in a unidirectional direction, impregnating the continuous fibers in a thermoplastic resin to form a single-layer prepreg, and then laminating at least two layers of the single-layer prepreg in different directions.

The fiber mat prepreg is a prepreg formed by irregularly arranging fibers and impregnating the fibers in the thermoplastic resin.

The sandwich structure composite material includes an upper skin, a lower skin, and a sandwich disposed between the upper skin and the lower skin. Manufacturing materials of the upper skin and the lower skin may both include: a fiber woven prepreg, a UD continuous fiber prepreg, a fiber mat prepreg, or a long-cut fiber-reinforced resin, so that the manufacturing materials of the upper skin and the lower skin both include continuous fibers. Definitely, the manufacturing materials of the upper skin and the lower skin may further include a short-cut fiber-reinforced resin and the like. This may increase impact resistance performance of the top cover to some extent. Due to a special structure of the sandwich structure composite material, a density of the material is low, so that a density of the top cover can be reduced, thereby reducing a weight of the radome and implementing a lightweight design.

The top cover may be set as a flat plate structure. When the continuous fiber-reinforced resin is used for manufacturing, the top cover may be set to be thin. Manufacturing costs of the top cover can be reduced, for example, the manufacturing costs can be reduced by 40%, and the radome may be formed after the top cover is connected to the side frame without additional thermal forming, thereby reducing manufacturing difficulty of the radome and simplifying a manufacturing process. A shape of the top cover may be any shape set based on an actual requirement, for example, but is not limited to a circle, an ellipse, a triangle, a quadrilateral, or another shape. This is not limited herein.

The first resin may be a thermoplastic resin or a thermosetting resin having high impact resistance performance, for example, but is not limited to: including PC (polycarbonate) and PU (polyurethane), and an impact resistance strength of the first resin may be greater than or equal to 10 KJ/m², to meet a performance requirement of the top cover when the top cover is used outdoors.

When the manufacturing material of the side frame includes the short fiber-reinforced resin, fibers in the side frame are short fibers, which are short. The short fiber can be used to improve impact resistance performance of the side frame and reduce a weight. In addition, the manufacturing material of the side frame is a resin material, which facilitates molding and facilitates production of a required shape.

When the short fiber-reinforced resin is used for manufacturing, a length of the short fiber may be not greater than 25 mm, for example, but not limited to: the short fiber may be a short-cut glass fiber, and a length of the short-cut glass fiber may be 0.7 mm to 1 mm; or the short fiber may be a long-cut glass fiber, and a length of the long-cut glass fiber may be 6 mm to 25 mm. A material of the short fiber may be, but is not limited to, one or a combination of the following:

a glass fiber, a quartz fiber, and a mineral fiber. Using such fiber may enhance impact resistance performance of the resin, thereby improving impact resistance performance of the side frame. In addition, when the side frame is manufactured by using the resin, a material having a desired impact resistance performance may be selected. The selection may be performed based on a requirement on impact resistance performance of the side frame, so that impact resistance performance can be improved to some extent, and a requirement for protecting an internal component of the radome is met.

An impact resistance strength of the second resin may be less than that of the first resin, and the second resin may be a thermoplastic resin or a thermosetting resin, for example, but is not limited to: including an ABS (acrylonitrile-butadiene-styrene copolymer), a PC-ABS alloy, a nylon, a polyester, a polysulfone, a polyimide, a polyether, and the like. There is no high requirement on the impact resistance strength of the second resin, provided that the requirement is met. This is not limited herein.

Based on this, the top cover and the side frame are made of different materials, and the top cover is made of a high-strength light material, so that a lightweight design of the radome can be implemented, thereby reducing an overall weight of the radome by 55%. In addition, the radome has high impact resistance performance, and passes a hoisting collision test and an impact resistance test, thereby improving reliability of the radome.

It should be understood that embodiments of the three radomes may be implemented separately, or may be implemented together. This may be designed based on an actual situation, and is not limited herein. In addition, when the foregoing three embodiments are combined for implementation, it indicates that the top cover and the side frame are made of different materials, and the end face of the top cover is embedded into the side frame or the top cover is lapped onto the side frame, so that a lightweight design and a design of high impact resistance performance of the radome can be implemented, and reliability of the radome can be effectively improved. Therefore, the radome has better performance.

The following describes a performance test of the radome.

Embodiment 1: a manner of connecting a top cover and a side frame is: an end face of the top cover is embedded into the side frame, a through hole may be disposed in the top cover embedded into the side frame, and an extension part of the side frame is inserted into the through hole, as shown in FIG. 4A and FIG. 4B. The top cover is made of a polypropylene UD unidirectional glass fiber prepreg, where four layers of UD unidirectional glass fiber prepregs are laminated, and an arrangement direction is [0/90/90/0]. After the four layers of UD unidirectional glass fiber prepregs are laminated, a thickness of the top cover is 1 mm. A proportion of a glass fiber in the prepreg is 50% to 60%. The side frame is made of a non-regularly oriented glass fiber-reinforced polypropylene material. A fiber is a long-cut glass fiber with a length of 6 mm to 25 mm and content of the glass fiber being 10% to 30%.

A manufacturing process of the radome includes the following steps. S1: put the polypropylene UD unidirectional glass fiber prepreg with the thickness of 1 mm into a mold, position the prepreg on an inner wall of the mold through vacuum adsorption, and increase a temperature of the mold to 70 °C. S2: close the mold, inject the long-cut glass fiber-reinforced polypropylene material melted in an injection molding machine into a mold cavity, to completely wrap a periphery of the prepreg, and form the side frame, where a molten plastic penetrates a through hole of the prepreg to form a rubber nail. S3: perform demolding after cooling, to obtain the radome having a composite structure.

Embodiment 2: a manner of connecting a top cover and a side frame is: the top cover is lapped onto a step of the side frame, and an outer surface of the top cover is flush with a surface of one side that is of the side frame and that is away from an accommodation cavity, as shown in FIG. 5A. The top cover is made of a polypropylene glass fiber fabric prepreg. A glass fiber fabric is selected at 600 grams per square meter (gsm) or 420 gsm. A thickness of the fabric prepreg is 1 mm. A proportion of a glass fiber in the prepreg is 35% to 55%. The side frame is made of a non-regularly oriented glass fiber-reinforced polypropylene material. A fiber is a long-cut glass fiber with a length of 6 mm to 25 mm and content of the glass fiber being 10% to 30%.

A manufacturing process of the radome includes the following steps. S1: put the polypropylene glass fiber fabric prepreg with the thickness of 1 mm into a mold, position the prepreg on an inner wall of the mold through vacuum adsorption, and increase a temperature of the mold to 70 °C. S2: close the mold, inject the long-cut glass fiber-reinforced polypropylene material melted in an injection molding machine into a mold cavity, and embed a molding side frame a desired distance into an inner surface of the prepreg to form reliable connection. S3: perform demolding after cooling, to obtain the radome having a composite structure.

Embodiment 3: a manner of connecting a top cover and a side frame is: an end face of the top cover is embedded into the side frame, but no through hole is disposed on the top cover. The top cover is made of a polycarbonate prepreg skin+a foam sandwich composite material. The polycarbonate skin uses electronic cloth, with a thickness of 0.3 mm, whose content of glass fibers is 35% to 55%. A foam core, with a thickness of 2.4 mm, uses a polyethylene terephthalate foam or a polypropylene foam. A total thickness of the polycarbonate prepreg skin+the foam sandwich composite material is 3 mm. The side frame is made of a pure polycarbonate material or a short glass fiber-reinforced polycarbonate material. A length of a short-cut glass fiber is 0.7 mm to 1 mm, and content of the glass fiber is 10%.

A manufacturing process of the radome includes the following steps. S1: put the polycarbonate prepreg skin+the foam sandwich composite material with the thickness of 3 mm into a mold, and position the polycarbonate prepreg skin+the foam composite material on an inner wall of the mold through vacuum adsorption. S2: close the mold, inject the long-cut glass fiber-reinforced polypropylene material melted in an injection molding machine into a mold cavity, to completely wrap a periphery of the foam sandwich composite material, and form the side frame. S3: perform demolding after cooling, to obtain the radome having a composite structure.

Embodiment 4: a manner of connecting a top cover and a side frame is: an end face of the top cover is embedded into the side frame, but no through hole is disposed on the top cover. The top cover is made of a polycarbonate glass fiber fabric prepreg. A glass fiber fabric is selected at 600 gsm or 420 gsm. A thickness of the fabric prepreg is 1 mm. A proportion of a glass fiber in the prepreg is 35% to 55%. The side frame is made of a short-cut glass fiber-reinforced polycarbonate material. A length of a short-cut glass fiber is 0.7 mm to 1 mm, and content of the glass fiber is 10%.

A manufacturing process of the radome includes the following steps. S1: put the polycarbonate glass fiber fabric prepreg with the thickness of 1 mm into a mold, and position the prepreg on an inner wall of the mold through vacuum adsorption. S2: close the mold, inject the long-cut glass fiber-reinforced polypropylene material melted in an injection molding machine into a mold cavity, to completely wrap a periphery of the prepreg, and form the side frame. S3: perform demolding after cooling, to obtain the radome having a composite structure.

Comparative example 1: the top cover and the side frame are integrated in injection molding, and are made of glass fiber-reinforced polypropylene materials. A fiber is a long-cut glass fiber, and content of the glass fiber in the top cover is 30%. Content of the glass fiber in the side frame is 10% to 30%, and a thickness of the top cover is 3.3 mm. A manufacturing process of the radome is any process that can implement integrated injection molding. Details are not described herein again.

Comparative example 2: the top cover and the side frame are integrated in injection molding, and are made of short glass fiber-reinforced polycarbonate materials. A fiber is a short-cut glass fiber, and content of the glass fiber in the top cover is 10%. Content of the glass fiber in the side frame is 10%, and a thickness of the top cover is 2.8 mm. A manufacturing process of the radome is any process that can implement integrated injection molding. Details are not described herein again.

After a weight test, an impact resistance performance test, a hoisting collision test, and a low-temperature ball drop test are performed in the foregoing four embodiments and two comparative examples, test results are shown in Table 1 below. Resins used in Comparative example 1, Embodiment 1, and Embodiment 2 are all polypropylenes, so test results of Embodiment 1 and Embodiment 2 may be compared with those in Comparative example 1. Resins used in Comparative example 2, Embodiment 3, and Embodiment 4 are all polycarbonates, so test results of Embodiment 3 and Embodiment 4 may be compared with those in Comparative example 2.

TABLE 1

| | Weight | | | Whether to |
|---|---|---|---|---|
| | reduction | Impact | Whether to | pass a low- |
| | effect of | resistance | pass a hoisting | temperature |
| | a radome | height | collision test | ball drop test |
| Comparative | A | 1.3 m | Yes | Yes |
| example 1 | | | | |
| Embodiment 1 | 0.55 A | >1.3 m | Yes | Yes |
| Embodiment 2 | 0.45 A | >1.3 m | Yes | Yes |
| Comparative | B | >1.3 m | Yes | Yes |
| example 2 | | | | |
| Embodiment 3 | 0.6 B | >1.3 m | Yes | Yes |
| Embodiment 4 | 0.66 B | >1.3 m | Yes | Yes |

It can be found from the results shown in Table 1 that: the top cover and the side frame are made of different materials. When the top cover is made of the polypropylene UD unidirectional glass fiber prepreg, the polypropylene glass fiber fabric prepreg, the polycarbonate prepreg skin+the foam sandwich composite material, and the polycarbonate glass fiber fabric prepreg, the weight of the radome can be effectively reduced to achieve better weight reduction effect, the impact resistance performance can be improved, and the hoisting collision test and low-temperature ball test can be passed.

Clearly, a person skilled in the art can make various modifications and variations to embodiments of this application without departing from the spirit and scope of embodiments of this application. In this case, this application is intended to cover these modifications and variations of embodiments of this application provided that they fall within the scope of protection defined by the following claims and their equivalent technologies.

1. A radome, comprising:
a side frame; and
a top cover, the top cover being connected to the side frame of the radome to form an accommodation cavity for accommodating a radiating element, the top cover being welded or glued to the side frame.

2. The radome according to claim 1, wherein an end face of the top cover is embedded into the side frame.

3. The radome according to claim 2, wherein a through hole is disposed in the top cover and the top cover is embedded into the side frame, the through hole penetrating the top cover in a thickness direction of the top cover, the side frame has an extension part, and the extension part is inserted into the through hole.

4. The radome according to claim 1, wherein one end of the side frame that faces the top cover has a step, the top cover is lapped onto the step, and the top cover is welded to the side frame.

5. The radome according to claim 4, wherein the step is disposed on a surface of one side of the side frame that is away from the accommodation cavity, or the step is disposed on a surface of one side of the side frame that faces the accommodation cavity.

6. The radome according to claim 5, wherein the step is disposed on the surface of the side of the side frame that is away from the accommodation cavity, the surface of the side of the side frame that is away from the accommodation cavity in a first direction is flush with a surface of one side of the top cover that is away from the accommodation cavity in the first direction, and the first direction is a direction perpendicular to the surface of the top cover.

7. The radome according to claim 1, wherein a first connecting part is disposed at one end that is of the top cover and that is connected to the side frame, a second connecting part is disposed at one end that is of the side frame and that is connected to the top cover, and the first connecting part is configured to matingly connect to the second connecting part.

8. The radome according to claim 7, wherein the first connecting part is a notch or a groove and the second connecting part is a protrusion; or
the first connecting part is a protrusion and the second connecting part is a notch or a groove.

9. The radome according to claim 1, wherein a manufacturing material of the top cover comprises a continuous fiber-reinforced thermoplastic resin, and a manufacturing material of the side frame comprises a thermoplastic resin or a short fiber-reinforced thermoplastic resin.

10. A radome according to claim 1, a manufacturing material of the top cover comprises at least one of a first resin, a continuous fiber-reinforced resin, a fiber mat prepreg, or a skin material, namely, a sandwich structure composite material comprising continuous fibers, and a manufacturing material of the side frame comprises a second resin or a short fiber-reinforced resin, wherein the first resin is different from the second resin.

11. The radome according to claim 10, wherein an impact resistance strength of the first resin is greater than or equal to 10 KJ/m².

12. The radome according to claim 10, wherein a length of a short fiber in the short fiber-reinforced resin is not greater than 25 mm.

13. An antenna, comprising:
a radiating element; and
a radome, the radome comprising:
a side frame; and
a top cover, the top cover being connected to the side frame of the radome to form an accommodation cavity for accommodating the radiating element, the top cover being welded or glued to the side frame;
wherein the radome covers the radiating element.

14. The antenna according to claim 13, wherein an end face of the top cover is embedded into the side frame.

15. The antenna according to claim 14, wherein a through hole is disposed in the top cover embedded into the side frame, the through hole penetrating the top cover in a thickness direction of the top cover, the side frame has an extension part, and the extension part is inserted into the through hole.

16. The antenna according to claim 13, wherein one end of the side frame that faces the top cover has a step, the top cover is lapped onto the step, and the top cover is welded to the side frame.

17. A communication device comprising an antenna, the antenna comprising:
a radiating element;
a radome, the radome comprising:
a side frame; and
a top cover, the top cover being connected to the side frame of the radome to form an accommodation cavity for accommodating the radiating element, the top cover being welded or glued to the side frame;
wherein the radome covers the radiating element.

18. The communication device according to claim 17, wherein an end face of the top cover is embedded into the side frame.

19. The communication device according to claim 18, wherein a through hole is disposed in the top cover embedded into the side frame, the through hole penetrates the top cover in a thickness direction of the top cover, the side frame has an extension part, and the extension part is inserted into the through hole.

20. The communication device according to claim 17, wherein one end of the side frame that faces the top cover has a step, the top cover is lapped onto the step, and the top cover is welded to the side frame.
